(19) United States
(12) Patent Application Publication
(10) Pub. No.: US 2002/0036862 A1
(43) Pub. Date: Mar. 28, 2002

(54) Air dam for a disc drive

(75) Inventors: Alan Hing-Bun Tsang, Bloomington, MN (US); Narintr Narisaranukul, Bloomington, MN (US); James Eiji Kaneko, Oakdale, MN (US); Blaine Thomas Peterson, Bloomington, MN (US); Carl Fred Adams, Yukon, OK (US)

Correspondence Address: SCHWEGMAN, LUNDBERG, WOESSNER & KLUTH, P.A., P.O. BOX 2938, MINNEAPOLIS, MN, 55402, US

(73) Assignee: Seagate Technology LLC

(21) Appl. No.: 09/901,318

(22) Filed: Jul. 9, 2001

Related U.S. Application Data
(60) Provisional application No. 60/235,613, filed on Sep. 27, 2000.
(60) Provisional application No. 60/277,782, filed on Mar. 21, 2001.

(51) Int. Cl. G11B 17/02

(52) U.S. Cl. 360/97.02

(57) ABSTRACT

A disc drive includes a base, at least one disc rotatably attached to the base, and an actuator assembly rotatably attached to base. The actuator assembly also has a suspension assembly having an attached end and a free end. The suspension assembly further includes a slider attached to attached to the free end of the suspension assembly; and a transducer attached to the slider. The slider and transducer are positioned to be in transducing relation with respect to the disc. The slider and transducer are rotated through an arc over the disc. An air dam is positioned over the disc and near the arc through which the slider and transducer are rotated. The air dam is positioned so as to produce an area of high pressure substantially about an area including a portion of the arc through which the slider and transducer are rotated.

### RELATED APPLICATION

This application claims the benefit of U.S. Provisional Application Serial No. 60/235,613 filed Sep. 27, 2000 and claims the benefit of U.S. Provisional Application Serial No. 60/277,782 filed Mar. 21, 2001 under 35 U.S.C. 119(e).

### FIELD OF THE INVENTION

The present invention relates to the field of mass storage devices. More particularly, this invention relates to an apparatus and method for lessening the vibration of sliders and attached transducers. This invention also relates to an apparatus and method for lessening runout resulting from vibration of the slider and attached transducer.

### BACKGROUND OF THE INVENTION

One key component of any computer system is a device to store data. Computer systems have many different places where data can be stored. One common place for storing massive amounts of data in a computer system is on a disc drive. The most basic parts of a disc drive are an information storage disc that is rotated, an actuator that moves a transducer to various locations over the disc, and electrical circuitry that is used to write and read data to and from the disc. The disc drive also includes circuitry for encoding data so that it can be successfully retrieved and written to the disc surface. A microprocessor controls most of the operations of the disc drive as well as passing the data back to the requesting computer and taking data from a requesting computer for storing to the disc.

The transducer is typically placed on a small ceramic block, also referred to as a slider, that is aerodynamically designed so that it flies over the disc. The slider is passed over the disc in a transducing relationship with the disc. Most sliders have an air-bearing surface (“ABS”) which includes rails and a cavity between the rails. When the disc rotates, air is dragged between the rails and the disc surface causing pressure, which forces the head away from the disc. At the same time, the air rushing past the cavity or depression in the air bearing surface produces a negative pressure area. The negative pressure or suction counteracts the pressure produced at the rails. The slider is also attached to a load spring which produces a force on the slider directed toward the disc surface. The various forces equilibrate so the slider flies over the surface of the disc at a particular desired fly height. The fly height is the distance between the disc surface and the transducing head, which is typically the thickness of the air lubrication film. This film eliminates the friction and resulting wear that would occur if the transducing head and disc were in mechanical contact during disc rotation. In some disc drives, the slider passes through a layer of lubricant rather than flying over the surface of the disc.

Information representative of data is stored on the surface of the storage disc. Disc drive systems read and write information stored on tracks on storage discs. Transducers, in the form of read/write heads attached to the sliders, located on both sides of the storage disc, read and write information on the storage discs when the transducers are accurately positioned over one of the designated tracks on the surface of the storage disc. The transducer is also said to be moved to a target track. As the storage disc spins and the read/write head is accurately positioned above a target track, the read/write head can store data onto a track by writing information representative of data onto the storage disc. Similarly, reading data on a storage disc is accomplished by positioning the read/write head above a target track and reading the stored material on the storage disc. To write on or read from different tracks, the read/write head is moved radially across the tracks to a selected target track.

The methods for positioning the transducers can generally be grouped into two categories. Disc drives with linear actuators move the transducer linearly generally along a radial line to position the transducers over the various tracks on the information storage disc. Disc drives also have rotary actuators which are mounted to the base of the disc drive for arcuate movement of the transducers across the tracks of the information storage disc. Rotary actuators position transducers by rotationally moving them to a specified location on an information recording disc. A rotary actuator positions the transducer quickly and precisely.

The actuator is rotatably attached to a shaft via a bearing cartridge which generally includes one or more sets of ball bearings. The shaft is attached to the base and may be attached to the top cover of the disc drive. A yoke is attached to the actuator and is positioned at one end of the actuator. The voice coil is attached to the yoke at one end of the rotary actuator. The voice coil is part of a voice coil motor which is used to rotate the actuator and the attached transducer or transducers. A set of permanent magnets is attached to the base and cover of the disc drive. The voice coil motor which drives the rotary actuator comprises the voice coil and the permanent magnet. The voice coil is attached to the rotary actuator and the permanent magnet is fixed on the base. A top plate and a bottom plate are generally used to attach the set of permanent magnets of the voice coil motor to the base. The top plate and the bottom plate also direct the flux of the set of permanent magnets. Since the voice coil sandwiched between the set of permanent magnets and top plate and bottom plate which produces a magnetic field, electricity can be applied to the voice coil to drive it so as to position the transducers at a target track.

One problem associated with disc drives is that the actuator assembly may resonate or vibrate at certain frequencies which in turn causes the transducer within the slider to move off-track. In other words, if there is even a slight vibration, the slider may move away from the center of a track during a track following operation. If the vibration is too large, the transducer continuously crosses the track to be followed and little if any information can be read. Writing can not be accomplished since there is a risk, at these times, that the transducer may be positioned over another adjacent track and attempting to write may result in overwriting other data that is necessary. The source of vibration may be the natural resonance of an actuator assembly or may be due to other influences. One of these influences is airflow generated by the rotating discs. The airflow generated by the rotating disc or discs (also referred to as windage) excites head suspensions which in turn cause the slider and transducers to vibrate. The vibration causes runout which is off-track motion. Of course as the density of tracks is increased, runout due to smaller vibrations becomes more critical.

What is needed is a disc drive that reduces vibration of the suspension and attached transducer and slider resulting from airflow between the spinning discs in a disc drive. What is also needed is a disc drive in which there is less off-track motion or runout. There is a constant need for a disc drive which has additional capacity as well as increased reliability without an appreciable rise in the error rate. There is also a need for methods and apparatus to reduce vibrations in the suspension and attached slider and transducer.

### SUMMARY OF THE INVENTION

A disc drive includes a base, a spindle rotatably attached to the base, and a plurality of discs attached to the spindle. An actuator assembly is rotatably attached to base. The actuator assembly further includes a plurality of suspension assemblies. Each suspension assembly has an attached end and a free end. Each suspension assembly further includes a slider attached to the free end of the suspension assembly, and a transducer attached to the slider. The slider and transducer are positioned in transducing relation with respect to a disc surface. The slider and transducer are rotated through an arc over the disc. An air dam is positioned over the at least one disc, and near the arc through which the slider and transducer are rotated. In some embodiments, the air dam is positioned to produce an area of high pressure which includes a portion of the arc through which the slider and the transducer are rotated. In other embodiments, the air dam is positioned so as to produce an area of high pressure substantially about an area including the transducer and slider while the actuator rotates and while the slider and transducer are in transducing relation with respect to the disc. The air dam further includes a finger interleaved between at least two of the plurality of discs. In some embodiments, the air dam further includes a plurality of fingers and at least one of the plurality of fingers is interleaved between at least two of the plurality of discs.

In some embodiments, the disc drive further includes a fin structure which has a plurality of fins located near the periphery of the plurality of discs. At least one fin of the fin structure is substantially coplanar with at least one disc. Furthermore, at least one of the plurality of fingers is interleaved between at least two of the plurality of discs. In some embodiments, the air dam is connected to the fin structure. The air dam may be rotatably connected to the plurality of fins such that the plurality of fingers of the air dam fit between the plurality of fins of the fin structure. The air dam is capable of a first folded position where the plurality of fingers of the air dam are folded between the plurality of fins of the fin structure, and a second deployed position where the plurality of fingers of the air dam are positioned away from the plurality of fins. When in the deployed position, the fingers of the air dam produce a high pressure area on one side of the plurality of fingers and a low pressure area on the other side of the plurality of fingers. The air dam is positioned to place the slider and attached transducer in the high pressure area produced by the air dam as the slider and attached transducer pass along at least a portion of the arc.

A disc drive includes a base, at least one disc rotatably attached to the base, and an actuator assembly rotatably attached to base. The actuator assembly also has a suspension assembly having an attached end and a free end. The suspension assembly further includes a slider attached to attached to the free end of the suspension assembly; and a transducer attached to the slider. The slider and transducer are positioned to be in transducing relation with respect to the disc. The slider and transducer are rotated through an arc over the disc. An air dam is positioned over the disc and near the arc through which the slider and transducer are rotated. The air darn is positioned so as to produce an area of high pressure substantially about an area including a portion of the arc through which the slider and transducer are rotated. In some embodiments, the air dam is positioned so as to produce an area of high pressure substantially about an area including the transducer and slider while the actuator rotates and while the slider and transducer are in transducing relation with respect to the disc. The air dam is positioned so as to produce an area of high pressure on one side of the air dam and an area of low pressure on the other side of the air dam. The area of high pressure is substantially about an area including the arc through which the slider and transducer are rotated. The disc drive also includes a cover. The cover further includes a breather filter which is positioned adjacent the low pressure area on the other side of the air dam. In some embodiments, an air channel which includes a filter may be used. In this instance, the position of the opening for makeup air may be anywhere in the housing. The outlet of the air channel is positioned at the downstream side of the fingers of the air dam. In some embodiments, the disc drive also includes at least one fin positioned near the outer periphery of at least one disc. The fin is substantially coplanar with the at least one disc. In some embodiments the air dam is connected to the at least one fin. The air dam is rotatably attached to the at least one fin, so that the air dam folds with respect to the at least one fin.

Advantageously, the air dam reduces vibration of the suspension and attached transducer and slider resulting from airflow between the spinning discs in a disc drive. Since the vibration is lessened or reduced, there is less off-track motion, which is also known as runout. Use of the above inventions provides for a disc drive which has additional capacity as well as increased reliability. The disc drive using an air dam can store additional information without an appreciable rise in the error rate. The disc may be formatted with a higher track density so that additional data to be stored on the disc. An additional advantage is that access times to information including customer data is improved since vibrations in the suspension and attached slider and transducer have been reduced.

These and various other features as well as advantages which characterize the present invention will be apparent upon reading of the following detailed description and review of the associated drawings.

### BRIEF DESCRIPTION OF THE DRAWINGS

FIG. 1 is an isometric view of a disc drive in which several discs have been removed to show the actuator assembly and air dam of the disc drive.

FIG. 2 is top view of the disc drive showing the actuator assembly and air dam of the disc drive.

FIG. 3 is a top view of the disc drive with the cover thereon.

FIG. 4 is an isometic view of the air dam and fin assembly where the air dam is in a deployed position.

FIG. 5 is an isometic view of the air dam and fin assembly where the air dam is in a folded position.

FIG. 6 is an isometric view of a disc drive showing the actuator assembly and the integral ramp and air dam assembly of the disc drive.

FIG. 7 is top view of the disc drive shown in FIG. 6.

FIG. 8 is an isometric view of the integral ramp and air dam assembly removed from the disc drive.

FIG. 9 is a flow chart indicating the method for adding the integral ramp and air dam assembly to a disc drive and merging the actuator assembly into the disc stack.

FIG. 10 is a schematic view of a computer system.

### DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

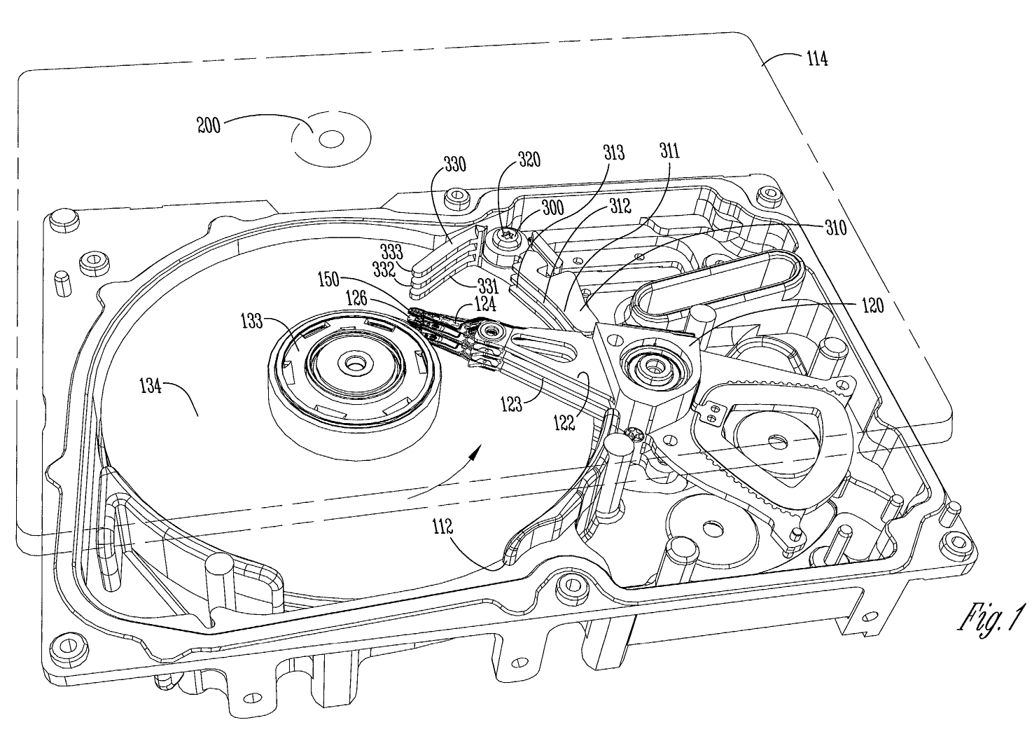

The invention described in this application is useful with all mechanical configurations of disc drives having either rotary or linear actuation. In addition, the invention is also useful in all types of disc drives, floppy disc drives and any other type of disc drives. FIG. 1 is an isometric view of a disc drive 100 in which several discs have been removed to more clearly show an actuator assembly 120 and an air dam and fin structure 300 of the disc drive 100. The disc drive 100 includes a housing or base 112, and a cover 114. The base 112 and cover 114 form a disc enclosure. Rotatably attached to the base 1 12 on an actuator shaft 118 is an actuator assembly 120. The actuator assembly 120 includes a comb-like structure 122 having a plurality of arms 123. Attached to the separate arms 123 on the comb 122, are load beams or load springs 124. Load beams or load springs are also referred to as suspensions. Attached at the end of each load spring 124 is a slider 126 which carries a magnetic transducer 150. The slider 126 with the transducer 150 form what is many times called the head. It should be noted that many sliders have one transducer 150 and that is what is shown in the figures. It should also be noted that this invention is equally applicable to sliders having more than one transducer, such as what is referred to as a magneto resistive (“MR”) or giant magneto resistive (“GMR”) head in which one transducer 150 is generally used for reading and another is generally used for writing. On the end of the actuator arm assembly 120 opposite the load springs 124 and the sliders 126 is a voice coil 128.

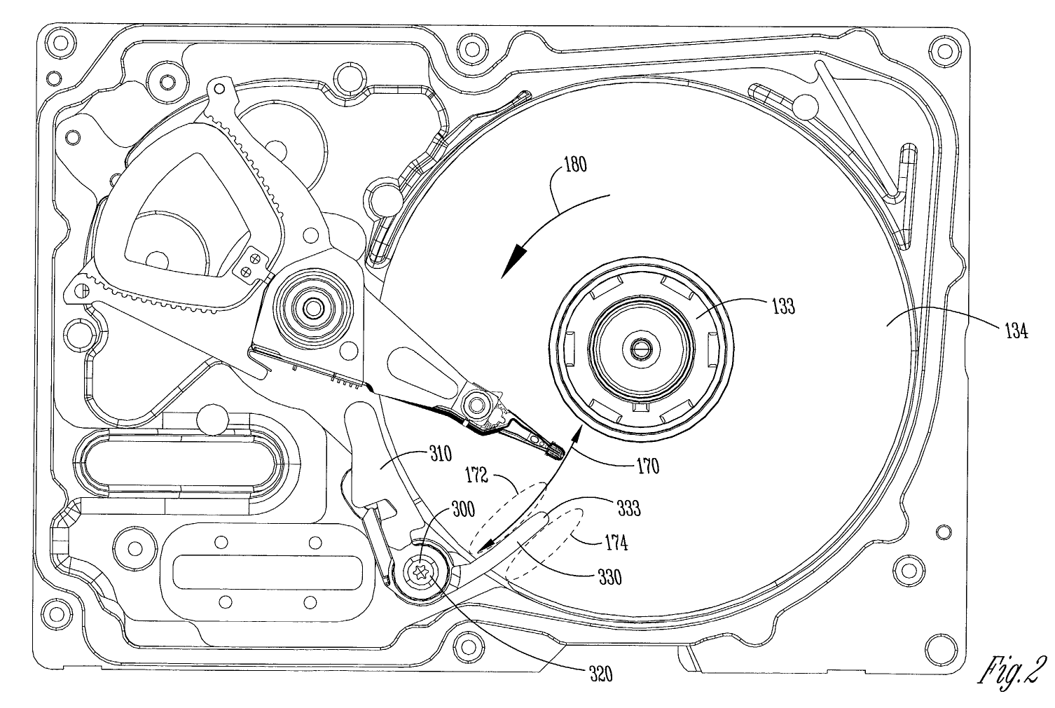

Attached within the base 112 is a first magnet 130 and a second magnet 131. As shown in FIG. 1, the second magnet 131 is associated with the cover 114. The first and second magnets 130, 131, and the voice coil 128 are the key components of a voice coil motor which applies a force to the actuator assembly 120 to rotate it about the actuator shaft 118. The voice coil motor formed from the voice coil 128 and the first and second magnets 130, 131 rotate the sliders and transducers along an arc 170 (shown as an double headed arrow in FIG. 2)

Also mounted to the base 112 is a spindle motor. The spindle motor includes a rotating portion called the spindle hub 133. In this particular disc drive, the spindle motor is not shown as the spindle motor within the hub. In FIG. 1, at least two discs 134 are attached to the spindle hub 133. The spindle hub and enclosed spindle motor rotate the discs 134 in the direction of arrow 180. As mentioned previously, in FIG. 1, the two discs 134 shown and attached to the spindle hub 133 are less than all the discs. By showing less than all the discs 134 the air dam and fin structure 300 as well as the actuator assembly 120 can be seen with more clarity.

FIG. 2 is top view of the disc drive 100 without the cover 114 which shows the actuator assembly and air dam of the disc drive. In FIG. 2, a plurality of discs 134 are attached to the spindle hub 133. Each of the discs 134 has a first recording surface and a second recording surface. Only one disc 134 is numbered for the sake of clarity. In other disc drives a single disc or a different number of discs may be attached to the hub. The invention described herein is equally applicable to disc drives which have a plurality of discs as well as disc drives that have a single disc. The invention described herein is also equally applicable to disc drives with spindle motors which are within the hub 133 or under the hub.

Now referring again to FIGS. 1 and 2, the air dam and fin structure 300 will be described in more detail. The air dam and fin structure 300 includes a set of fins 310, a pivot 320, and a plurality of fingers 330. The pivot point 320 includes a fastener which is used to fasten the fin structure and air dam 300 to the base 112. The fastener 322 of the pivot 320 also attaches the fin structure or fins 310 to the air dam structure or fingers 330. The fin structure 310 includes a number of fins. The number of fins generally is equal to the number of discs 134 within the disc drive. The fins 311, 312, 313 are positioned so that they are adjacent or near the edge of the discs 134 attached to the spindle 133. The fins, such as 311, 312, 313, essentially prevent or substantially reduce the turbulent air flow off the edge of the discs 134. The number of fins 311, 312, 313 generally equals the number of discs 134 in a disc pack. In other words, the number of fins 311, 312, 313 generally equals the number of discs 134 attached to the spindle 133. The fins 311, 312, 313 are curved slightly so that they conform to the outer periphery or outer diameter of the discs 135. The fins 311, 312, 313, are also about the same thickness or substantially the same thickness as the thickness of the discs 134. The fin structure 330 includes a plurality of fingers such as 331, 332 and 333. The fingers, such as 331, 332, 333, are positioned above the top disc in the disc pack and below the bottom disc in the disc pack as well as between each of the discs in the disc pack. The number of fingers 331, 332, 333 of the air dam structure 330 is generally one more than the number of discs in the disc pack or the number of discs 134 attached to the spindle hub 133. The fingers, such as 331, 332, 333 inhibit air flow generated by the rotating discs and produce a high pressure area 172 on the side of the fingers 331, 332, 333 toward which the disc rotates, as depicted by arrow 180. The area of high pressure 172 is encircled by a dotted line in FIG. 2. The area of high pressure is labeled element 172. The area is an approximate area and may change or vary somewhat depending upon the particular application of the air dam and fin structure 300 used in a particular disc drive 100. It should be noted that when the actuator assembly 120 is rotated toward the outer diameter of the disc, the slider and transducer and a portion of the suspension will be within the high pressure area 172. In other words, the slider and transducer and a portion of the suspension operate in the high pressure area produced by the fingers, such as 331, 332, 333, of the air dam structure 330. By operating within the high pressure area 172, the transducer and slider as well as the portion of the load beam are within a very stable area which is less prone to vibration due to windage. Windage is the air movement generated by the spinning discs 134 of the disc drive 100. Because the transducer and slider are in the more stable area it is less prone to vibration and is therefore less prone to run out error, which can be caused by vibration. The vibration of the transducer and slider will cause the transducer to pass over or move with respect to the center line of a particular track from which data is being read or to which data is being written.

The high pressure area 172 can be thought of as being upstream from the air dam structure 330 or upstream from each of the fingers, such as 331, 332, 333. Therefore, on one side of the fingers 331, 332, 333 there is created a high pressure area 172. One of the reasons that the high pressure area is formed is that the fingers 331, 332, 333 of the air dam structure 330 slow the velocity of the air movement within the disc drive. This slowing of the velocity of the air movement also adds to the stability within the high pressure area 172 on the one side of the fingers 331, 332, 333. In addition to creating a high pressure area on one side of the fingers, the air dam also slows the velocity of air movement within the entire disc enclosure which also tends to stabilize the slider and transducer. As a result there is less energy in the air and less energy to impart vibrations on the components within the disc drive. On the other side of the fingers 331, 332, 333 there is formed a low pressure area 174. The low pressure area 174 is generally one of the lowest pressure areas within the disc drive 100. The cover 114 of the disc drive 100 includes a breather filter 200. The breather filter 200 is positioned so that it is adjacent the low pressure area 174 created by the air dam structure 330 or by the fingers 331, 332, 333.

In the alternative, a structure which includes an air channel and a filter may be used to move the position of the opening for makeup air. When using the structure which includes an air channel, the opening for makeup air can be located in the deck or base 112 or cover 114. The outlet for the makeup air will be located near the low pressure area 174 downstream of the fingers 331, 332, 333.

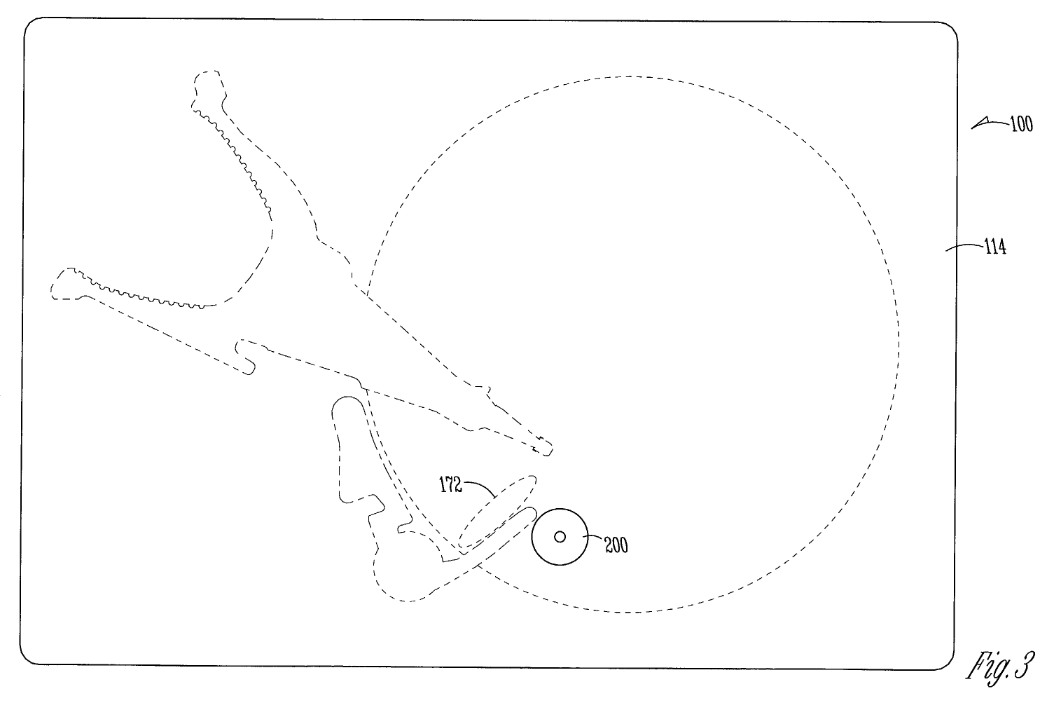

FIG. 3 shows a top view of the disc drive with the cover 114 thereon. The actuator assembly 120, the fin and air dam structure 300 and the discs 134 are shown in phantom. Also shown in phantom are the high pressure area 172 and the low pressure area 174. As can be seen, the air breather filter 200 is positioned over the low pressure area 174 within the disc drive 100. The air breather filter generally provides for filtered air when needed to be placed within the disc drive enclosure. Anther way of stating this is that the disc drive 100 sometimes needs makeup air. A breather filter is used or is placed at the low pressure point within the disc drive so that the makeup air will come through the breather filter 200 rather than through another opening within the disc drive which would be unfiltered. The breather filter generally removes contaminants that might cause a crash within a disc drive. For example, particles of smoke are large enough to cause a disc crash and the breather filter 200 filters the air to remove such particles so that a disc crash does not result. The discs 134 also carry a lubricant and the breather filter 200 also removes contaminants that might react with the lube on the discs 134.

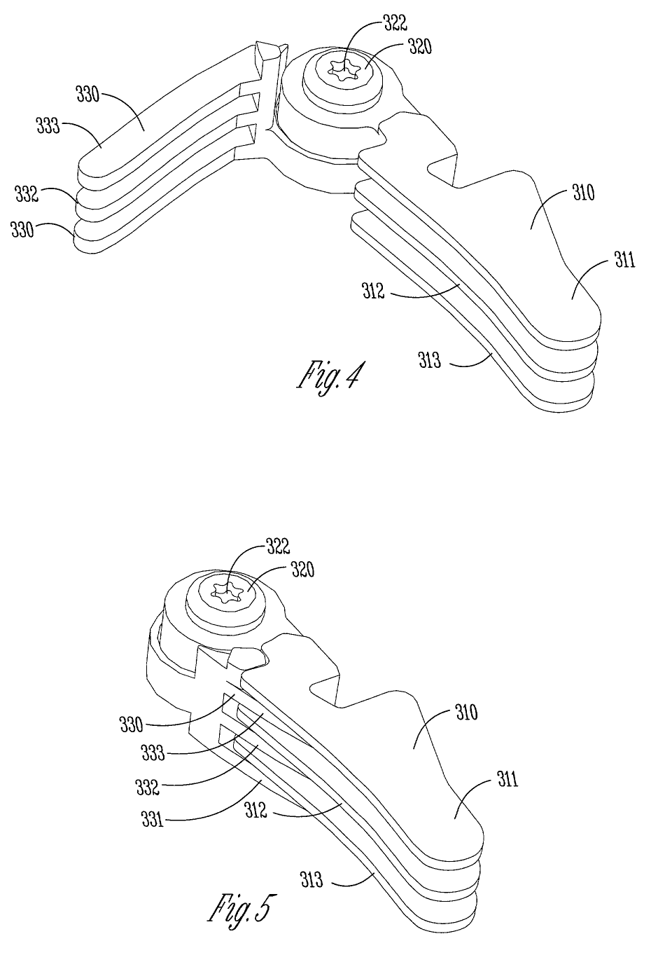

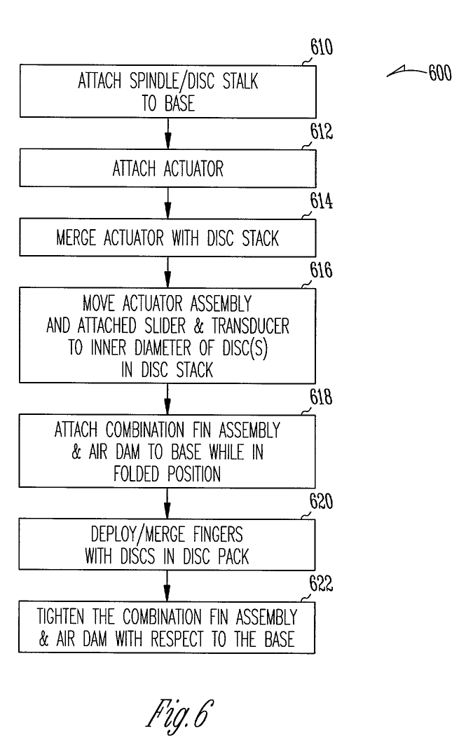

FIG. 4 is an isometric view of an air dam and fin assembly 300 where the air dam structure 330 is in a deployed position. FIG. 5 is a view of the air dam and fin assembly 300 where the air dam structure 330 is in a folded position with respect to the fin structure 310. As mentioned previously, the fin structure 310 and the air dam structure 330 are attached to one another by a fastener 322 at the pivot point 320. Therefore, looking at FIGS. 4 and 5 it can be seen that the air dam and fin structure can be folded much like the blades of a jack knife fold within the body of the jack knife. It should be noted that the fins 331, 332, 333 are adapted to be placed between the discs or on top or the bottom of the disc pack and that the fins, such as 311, 312, 313 of the fin structure 310 are adapted to be placed adjacent the disc. Therefore, the spacing and orientation of the fin structure 310 and the fingers 331, 332, 333 of the air dam allow for a folded position as shown in FIG. 5. The fins or the fin structure 310 acts much like the body of a jack knife in that they can house the blades or fingers, such as 331, 332, 333, of the air dam structure 330. Thus, the fin and air dam assembly 300 is capable of a first position in which the fingers of the air dam are folded within the fins of the fin structure 310. The fin and air dam assembly 300 is also capable of a deployed or unfolded position where the fingers are extended outwardly from the fin structure 310. The capability to place it into two positions is helpful and necessary for the manufacture of the disc drive 100.

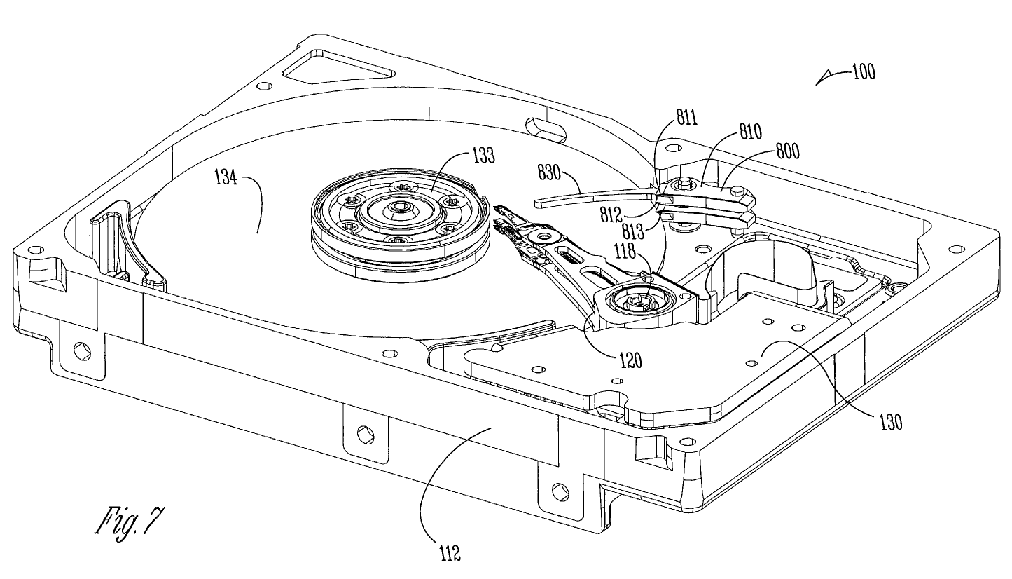

FIG. 6 is a flow chart indicating the method for adding the air dam and fin assembly 300 to a disc drive. Initially, the spindle and disc stack is attached to the base 112 of the disc drive 100, as depicted by reference numeral 610. The next step is to attach the actuator assembly 120, as depicted by step 612. The actuator assembly 120 is then merged with the discs 134 of the disc stack, as depicted by reference numeral 614. The actuator assembly 120 and attached slider and transducer are then moved to the inner diameter of the discs 134 of the disc stack, as depicted by reference numeral 616. The combination fin assembly and air dam 300 is then attached to the base 112 while the fin assembly and air dam 300 are in the folded position, as depicted by reference numeral 618. The next step is to place the combination fin assembly and air dam structure 300 into the deployed position. In other words, the air dam structure is deployed or unfolded from the fin structure 310. While this is done, the individual fingers such as 331, 332, 333 are merged with the discs 134 in the disc pack, as depicted by reference numeral 620. Once the fin assembly and air dam 300 are correctly positioned with respect to the discs 134 and with respect to the base, the fastener 322 at the pivot point 320 is tightened, as depicted by reference numeral 622. Therefore, it can be seen that since the combination structure for the air dam and fins 300 is capable of a first position where it is folded and a second position where it is deployed or unfolded is useful in manufacturing or assembling the disc drive 100. Having a folded and unfolded position allows the air dam and fin structure 300 to be placed within the disc drive so as to minimize change from current manufacturing practices.

Alternatively, the fin and air dam assembly 300 may be preinstalled within the base 112 with the fingers 331, 332, 333 folded with respect to the fins 311, 312, 313. The disc stack and actuator assembly 120 are attached to the base 112. The actuator assembly 120 is merged into the disc stack. Then the fingers 331, 332, 333 are unfolded or placed into the deployed position.

It should be noted that the placement of the fingers 331, 332, 333 of the fin structure downstream or close to the end of the actuator assembly 120 has a further advantage. Anytime a structure is placed into the path of wind formed by the spinning discs an additional amount of power is consumed. The placement of the air dam and fin structure, and especially the air dam structure 330, downstream from the actuator assembly 120 minimizes the amount of additional power necessary or consumed by the disc drive 100. By placing the air dam structure 330 downstream from the actuator assembly, the amount of additional power consumed is minimized since the actuator assembly is already obstructing the air flow. The air dam structure 330 has a minimal effect on the amount of additional power used since the actuator assembly is already obstructing the air flow path generated by the spinning discs 134.

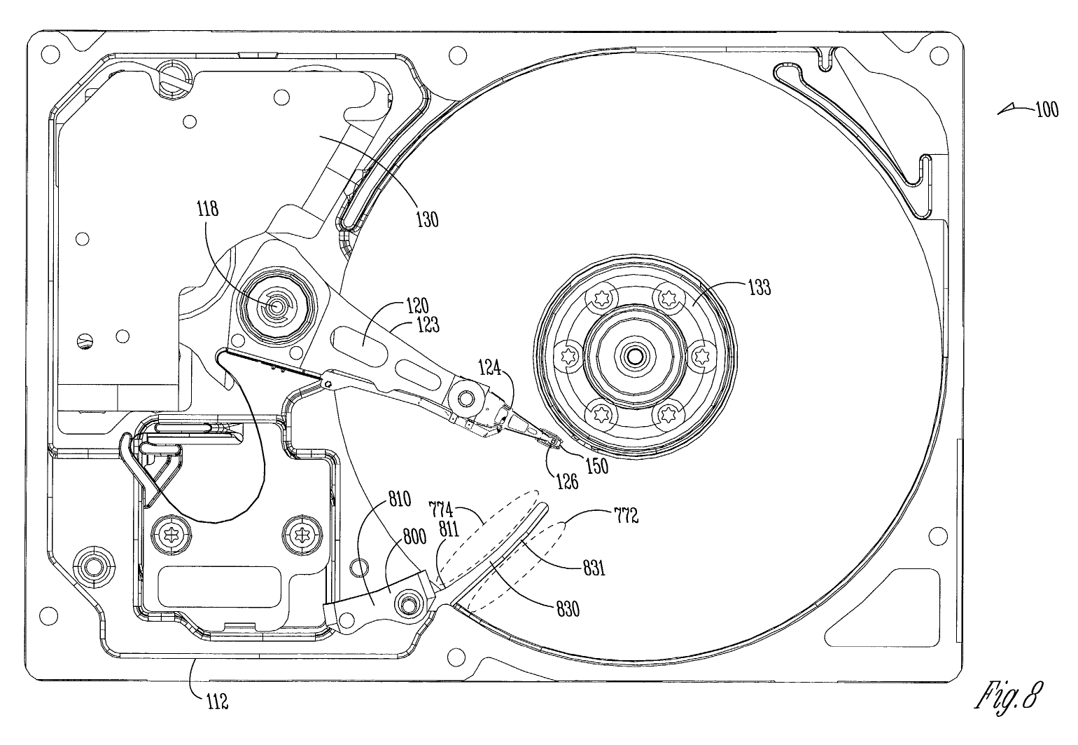

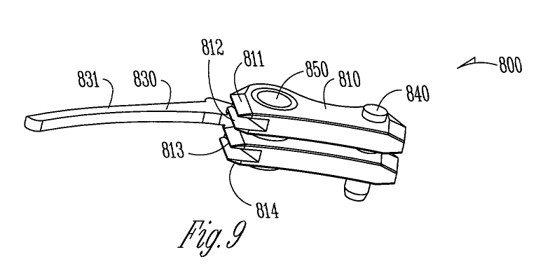

FIG. 7 is an isometric view of a disc drive 100 showing the actuator assembly 120 and having an integral ramp and air dam assembly 800. FIG. 8 is top view of the disc drive shown in FIG. 7. Now referring to FIGS. 7 and 8, the integral ramp and air dam structure 800 will be described in more detail. The integral ramp and air dam structure 800 includes a ramp structure 810 and an air dam structure 830. The disc drive 100 shown in FIGS. 7 and 8 has one of the discs 134 of the disc stack removed from the hub 133 for the sake of illustration. For example, as shown in FIG. 7, the top disc has been removed since two arms 123 of the actuator assembly 120 can be seen. Essentially, the disc drive 100 shown in FIG. 7 is a two-disc drive with the top disc or one of the discs 134 removed. The integrated ramp and air dam structure 800 includes an air dam which presents a slightly curved surface downstream or near the free end of the actuator assembly 120. In other words, the air dam 830 has a curved surface which, when positioned within the disc drive 100, is near the transducer 150 and slider 126 end of the actuator assembly 120. The air dam 830 has a first side and a second side. The first side of the air dam is positioned closest to the slider 126 and transducer 150 of the actuator assembly 120. On the first side, a high pressure area 772 is formed. The free end of the actuator or the end including the slider 126 and transducer 150 is positioned within the high pressure area 772 produced by the air dam 830. On the other side of the air dam is a low pressure area 774. The air dam 830 includes a single finger 831 which is positioned between a first and second disc 134 in the disc drive. The integral ramp and air dam structure 800 also includes a ramp structure 810 which includes a series of ramps 811, 812, 813 and 814.

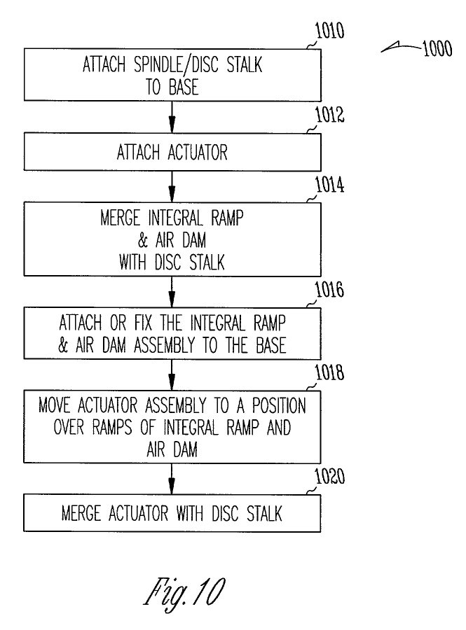

The integral ramp and air dam structure 800 is also shown in FIG. 9 which is an isometric view of the integrated ramp and air dam structure 800 as removed from the disc drive 100. FIG. 9 shows the ramp structures 811, 812, 813 and 814 as well as the single finger 831 of the air dam structure 830. The finger structure or air dam structure 830 does not move or is fixed with respect to the ramp structure 810 of the integral ramp and air dam structure 800. The integral ramp and air dam structure includes a pivot portion 840. The pivot portion 840 is basically a post which is molded into the integral ramp and air dam structure 800. The bottom of the post 840 fits within an opening in the base 112 of the disc drive 100 so that the integral ramp and air dam structure 800 can pivot. The integral air ramp and air dam structure 800 also includes an opening 850 for receiving a fastener. The fastener is passed through the opening 850 to fasten the integral ramp and air dam structure 800 to the base 112 of the disc drive 100. It should be noted that although only one finger 831 is shown as part of the air dam structure 830 in this particular example, there could be multiple fingers. The air dam structure also provides many of the same advantages of the previous air dam structure described more fully in FIGS. 1-6. Namely that there is increased stability of the free end of the actuator 120 or the end of the actuator including the slider and transducer 126, 150 since it operates in the high pressure area 772. The air dam portion of the structure 800 also slows the velocity of air flow within the disc enclosure and lessens the amount of energy in the air so that there is less energy to impart vibration on components, such as the actuator assembly 120, within the disc drive 100. The integral ramp and air dam structure 800 also provides for a minimal power loss since the actuator assembly 120 is forward or upstream from the air dam structure 830. In other words, the air dam 830 drafts off of the actuator assembly 120. An additional advantage is that the ramp structure 810 includes all the ramps onto which the various portions of the actuator assembly 120 must be positioned to park or offload the sliders and transducers from the surface of the disc. It is also a cost savings in that one part is needed rather than separate parts for a separate set of fingers or a separate air dam and a separate ramp structure.

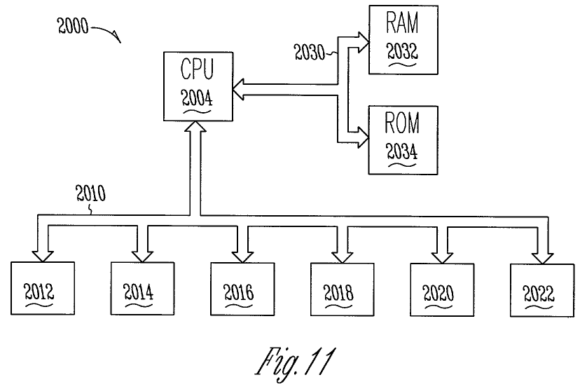

FIG. 10 is a flowchart indicating the method for adding the integral ramp and air dam assembly 800 to a disc drive 100. Initially, the spindle and disc stack are attached to the base 112 of the disc drive 100 as depicted by reference numeral 1010. The next step is to attach the actuator assembly 120 as depicted by step 1012. The next step is to merge the integral ramp and air dam structure 800 with the disc stack as depicted by reference numeral 1014. After the integral ramp and air dam structure 800 is merged with the disc stack, it is attached to the base, as depicted by step 1016. The actuator assembly 120 is then moved to a position over the ramps of the integral ramp and air dam structure 800, as depicted by step 1018. Then the actuator assembly 120 is merged with the disc stack as depicted by step 1020. Thus, having an integral air dam and ramp structure 800 provides an additional advantage in that the integral ramp and air dam structure can be used to help merge the actuator assembly with the disc stack.

Of course, it should be noted that the integral ramp and disc drive could be assembled so that the actuator assembly is merged into the disc stack before installation of the structure 800.

Advantageously, the air dam reduces vibration of the suspension and attached transducer and slider resulting from airflow between the spinning discs in a disc drive. Since the vibration is lessened or reduced, there is less off-track motion, which is also known as runout. Use of the above inventions provides for a disc drive which has additional capacity as well as increased reliability. The disc drive using an air dam can store additional information without an appreciable rise in the error rate. The disc may be formatted with a higher track density so that additional data to be stored on the disc. An additional advantage is that access times to information including customer data is improved since vibrations in the suspension and attached slider and transducer have been reduced.

FIG. 10 is a schematic view of a computer system. Advantageously, the invention is well-suited for use in a computer system 2000. The computer system 2000 may also be called an electronic system or an information handling system and includes a central processing unit, a memory and a system bus. The information handling system includes a central processing unit 2004, a random access memory 2032, and a system bus 2030 for communicatively coupling the central processing unit 2004 and the random access memory 2032. The information handling system 2002 includes a disc drive device which includes the ramp described above. The information handling system 2002 may also include an input/output bus 2010 and several devices peripheral devices, such as 2012, 2014, 2016, 2018, 2020, and 2022 may be attached to the input output bus 2010. Peripheral devices may include hard disc drives, magneto optical drives, floppy disc drives, monitors, keyboards and other such peripherals. Any type of disc drive may use the method for loading or unloading the slider onto the disc surface as described above.

Conclusion

In conclusion, a disc drive 100 includes a base 112, at least one disc 134 rotatably attached to the base 112, and an actuator assembly 120 rotatably attached to base 112. The actuator assembly 120 also has a suspension assembly 124 having an attached end and a free end. The suspension assembly 124 further includes a slider 126 attached to attached to the free end of the suspension assembly 124 and a transducer 150 attached to the slider 126. The slider 126 and transducer 150 are positioned to be in transducing relation with respect to the disc 134. The slider 126 and transducer 150 are rotated through an arc 170 over the disc 134. An air dam 330, 830 is positioned over the disc 134 and near the arc 170 through which the slider 126 and transducer 150 are rotated. The air dam 830, 330 is positioned so as to produce an area of high pressure 172 substantially about an area including a portion of the arc 170 through which the slider 126 and transducer 150 are rotated. In some embodiments, the air dam 830, 330 is positioned so as to produce an area of high pressure 172 substantially about an area including the transducer 150 and slider 126 while the actuator 120 rotates and while the slider and transducer are in transducing relation with respect to the disc 134. The air dam 330, 830 is positioned so as to produce an area of high pressure 172 on one side of the air dam and an area of low pressure 174 on the other side of the air dam 330, 830. The area of high pressure 172 is substantially about an area including the arc 170 through which the slider 126 and transducer 150 are rotated. The disc drive also includes a cover 114. The cover 114 further includes a breather filter which is positioned adjacent the low pressure area 174 on the other side of the air dam 330, 830. In some embodiments, the disc drive 100 also includes at least one fin 311 positioned near the outer periphery of at least one disc 134. The fin 131 is substantially coplanar with the at least one disc 134. In some embodiments the air dam 330 is connected to the at least one fin 311. The air dam is rotatably attached to the at least one fin, so that the air dam folds with respect to the at least one fin.

A disc drive 100 includes a base 112, a spindle 133 rotatably attached to the base 112, and a plurality of discs 134 attached to the spindle 133. An actuator assembly 120 is rotatably attached to base 112. The actuator assembly 120 further includes a plurality of suspension assemblies 124. Each suspension assembly 124 has an attached end and a free end. Each suspension assembly further includes a slider 126 attached to the free end of the suspension assembly 124, and a transducer 150 attached to the slider 126. The slider 126 and transducer 150 are positioned to be in transducing relation with respect to a disc 134 of the plurality of discs 134. The slider 126 and transducer 150 are rotated through an arc 170 over the disc 134. An air dam 330, 830 is positioned over the at least one disc 134, and near the arc 170 through which the slider 126 and transducer 150 are rotated. In some embodiments, the air dam 330, 830 is positioned to produce an area of high pressure 172 which includes a portion of the arc 170 through which the slider 126 and the transducer 150 are rotated. In other embodiments, the air dam 330, 830 is positioned so as to produce an area of high pressure 170 substantially about an area including the transducer 150 and slider 126 while the actuator 120 rotates and while the slider 126 and transducer 150 are in transducing relation with respect to the disc 134. The air dam 330, 830 further includes a finger 331, 831 interleaved between at least two of the plurality of discs 134. In some embodiments, the air dam 330 further includes a plurality of fingers 331, 332 and at least one of the plurality of fingers 331 is interleaved between at least two of the plurality of discs 134.

In some embodiments, the disc drive 100 further includes a fin structure which has a plurality of fins 311, 312 located near the periphery of the plurality of discs 134. At least one fin 311 of the fin structure 310 is substantially coplanar with at least one disc 134. Furthermore, at least one of the plurality of fingers 311 is interleaved between at least two of the plurality of discs 134. In some embodiments, the air dam 330 is connected to the fin structure 310. The air dam 330 may be rotatably connected to the plurality of fins 310 such that the plurality of fingers 331, 332 of the air dam fit between the plurality of fins 311, 312 of the fin structure 310. The air dam 310 is capable of a first folded position where the plurality of fingers 311, 312 of the air dam are folded between the plurality of fins 331, 332 of the fin structure 330, and a second deployed position where the plurality of fingers 331, 332 of the air dam are positioned away from the plurality of fins 311, 312. When in the deployed position, the fingers 331, 332 of the air dam 330 produce a high pressure area 170 on one side of the plurality of fingers 331, 332 and a low pressure area 174 on the other side of the plurality of fingers 331, 332. The air dam 330 is positioned to place the slider 126 and attached transducer 150 in the high pressure area 172 produced by the air dam 330 as the slider 126 and attached transducer 150 pass along at least a portion of the arc 170.

Most generally, a disc drive 100 includes a base 112, a disc 134 rotatably attached to the base 112, a rotatable actuator 120 having a slider 126 and transducer 150, and a device for placing the slider 126 and transducer 150 in a high pressure area 174 so as to reduce the vibration of the slider 126 and transducer 150 generated by airflow between a spinning disc 134 and the slider 126 and transducer 150.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A disc drive comprising:
a base;
at least one disc rotatably attached to the base;
an actuator assembly rotatably attached to base, the actuator assembly further comprising a suspension assembly having an attached end and a free end, the suspension assembly further comprising:
a slider attached to attached to the free end of the suspension assembly; and
a transducer attached to the slider and positioned to be in transducing relation with respect to the at least one disc, the slider and transducer rotated through an arc over the at least one disc;
an air dam positioned over the at least one disc and near the arc through which the slider and transducer are rotated.

2. The disc drive of claim 1 wherein the air dam is positioned so as to produce an area of high pressure substantially about an area including a portion of the arc through which the slider and transducer are rotated.

3. The disc drive of claim 1 wherein the air dam is positioned so as to produce an area of high pressure substantially about an area including the transducer and slider as the actuator rotates while the slider and transducer are in transducing relation with respect to the disc.

4. The disc drive of claim 1 wherein the air dam is positioned so as to produce an area of high pressure on one side of the air dam and an area of low pressure on the other side of the air dam, the area of high pressure substantially about an area including at least a portion of the arc through which the slider and transducer are rotated.

5. The disc drive of claim 4 further comprising a cover, the cover further comprising a breather filter, the breather filter positioned adjacent the low pressure area on the other side of the air dam.

6. The disc drive of claim 1 further comprising at least one fin positioned near the outer periphery of the at least one disc.

7. The disc drive of claim 6 wherein the at least one fin is substantially coplanar with the at least one disc.

8. The disc drive of claim 6 wherein the air dam is connected to the at least one fin.

9. The disc drive of claim 6 wherein the air dam is rotatably attached to the at least one fin, wherein the air dam folds with respect to the at least one fin.

10. The disc drive of claim 1 further comprising at least one ramp positioned near the outer diameter of the at least one disc.

11. The disc drive of claim 10 wherein the at least one ramp is adapted to receive a portion of the actuator assembly such that the slider and transducer are removed from a transducing relationship when placed on the ramp.

12. The disc drive of claim 10 wherein the air dam is connected to the at least one ramp.

13. The disc drive of claim 10 wherein the air dam is fixed with respect to the at least one ramp.

14. A disc drive comprising:
a base;
a spindle rotatably attached to the base;
a plurality of discs attached to the spindle;
an actuator assembly rotatably attached to base, the actuator assembly further comprising a plurality of suspension assemblies, each suspension assembly having an attached end and a free end, each suspension assembly further comprising:
a slider attached to the free end of the suspension assembly; and
a transducer attached to the slider and positioned to be in transducing relation with respect to a disc of the plurality of discs, the slider and transducer rotated through an arc over the disc;
an air dam positioned over the at least one disc and near the arc through which the slider and transducer are rotated.

15. The disc drive of claim 14 wherein the air dam is positioned to produce an area of high pressure which includes a portion of the arc through which the slider and the transducer are rotated.

16. The disc drive of claim 14 wherein the air dam is positioned so as to produce an area of high pressure substantially about an area including the transducer and slider as the actuator rotates while the slider and transducer are in transducing relation with respect to the disc.

17. The disc drive of claim 14 wherein the air dam further comprises a finger interleaved between at least two of the plurality of discs.

18. The disc drive of claim 14 wherein the air dam further comprises a plurality of fingers, at least one of the plurality of fingers interleaved between at least two of the plurality of discs.

19. The disc drive of claim 18 wherein the air dam further comprises:
a plurality of fingers;
a fin structure including a plurality of fins located near the periphery of the plurality of discs, wherein at least one fin is substantially coplanar with at least one disc of the plurality of discs, wherein at least one of the plurality of fingers are interleaved between at least two of the plurality of discs.

20. The disc drive of claim 19 wherein the air dam is connected to the fin structure.

21. The disc drive of claim 19 wherein the air dam is rotatably connected to the plurality of fins such that the plurality of fingers of the air dam fit between the plurality of fins of the fin structure.

22. The disc drive of claim 19 wherein the air dam is rotatably connected to the plurality of fins such that the plurality of fingers of the air dam fit between the plurality of fins of the fin structure so that the fin structure and air dam is capable of a first folded position where the plurality of fingers of the air dam are folded between the plurality of fins of the fin structure, and a second deployed position where the plurality of fingers of the air dam are positioned away from the plurality of fins.

23. The disc drive of claim 22 wherein the fingers of the air dam produce a high pressure area on one side of the plurality of fingers and a low pressure area on the other side of the plurality of fingers, the air dam positioned to place the slider and attached transducer in the high pressure area produced by the air dam as the slider and attached transducer pass along at least a portion of the arc.

24. The disc drive of claim 18 wherein the air dam further comprises:
a plurality of fingers;
a ramp structure including a plurality of ramps located near the periphery of the plurality of discs, wherein at least one ramp is positioned to remove the slider and transducer from the disc when the actuator is moved to the outer periphery of the disc, wherein at least one of the plurality of fingers are interleaved between at least two of the plurality of discs.

25. A disc drive comprising:
a base;
a disc rotatably attached to the base, said disc having tracks for storing information;
a rotatable actuator having a slider and transducer; and
means for placing the slider and transducer in a high pressure area so as to reduce the vibration of the slider and transducer generated by airflow between a spinning disc and the slider and transducer.

26. The disc drive of claim 25 wherein the means for placing the slider and transducer in a high pressure area comprises placing an air dam near the slider and transducer.

27. The disc drive of claim 25 wherein the means for placing the slider and transducer in a high pressure area further comprises:
an air dam positioned near the slider and transducer; and
at least one fin positioned near the outer periphery of the disc.

28. The disc drive of claim 27 wherein the air dam is connected to the at least one fin.

29. The disc drive of claim 27 wherein the air dam is connected to the at least one fin such that the air dam folds with respect to the at least one fin.

30. The disc drive of claim 25 wherein the means for placing the slider and transducer in a high pressure area further comprises:
an air dam positioned near the slider and transducer; and
a ramp positioned near the air dam.
